(19) United States
(12) Patent Application Publication
(10) Pub. No.: US 2026/0237357 A1
(43) Pub. Date: Aug. 13, 2026

(54) GATE DRIVER AND ELECTRONIC DEVICE

(71) Applicant: Samsung Display Co., Ltd., Yongin-si (KR)

(72) Inventors: JUNHYUN PARK, Yongin-si (KR); HWA-RANG LEE, Yongin-si (KR); JUNKI JEONG, Yongin-si (KR); NAHYEON CHA, Yongin-si (KR)

(21) Appl. No.: 19/462,780

(22) Filed: Jan. 28, 2026

(30) Foreign Application Priority Data
Feb. 10, 2025 (KR) 10-2025-0016582

(51) Int. Cl. G09G 3/3266; G09G 3/32

(52) U.S. Cl. CPC G09G 3/3266; G09G 3/32; G09G 2310/0267; G09G 2310/0286; G09G 2320/045

(57) ABSTRACT

A gate driver includes stages. A stage includes a logic circuit configured to control voltages of first and second nodes based on a first carry clock signal and an input signal, a first transistor connected between the first node and a third node, a second transistor connected between the first node and a fourth node, a first gate output circuit configured to output a first gate signal based on a second clock signal and voltages of the second and third nodes, a second gate output circuit configured to output a second gate signal based on a third clock signal and voltages of the second and fourth nodes, a carry output circuit configured to output a carry signal based on a second carry clock signal and the voltages of the second and fourth nodes, and a boosting capacitor connected between the fourth node and a carry output node.

### CROSS-REFERENCE TO RELATED APPLICATION

The present application claims priority to, and the benefit of, Korean Patent Application No. 10-2025-0016582, filed on February 10, 2025, in the Korean Intellectual Property Office, the entire disclosure of which is incorporated herein by reference.

### BACKGROUND

### 1. Field

Embodiments of the present disclosure relate to a gate driver in a display device, and an electronic device including the display device.

### 2. Description of the Related Art

A display device may include a display panel that includes a plurality of pixels, a data driver that provides data signals to the plurality of pixels, a gate driver that provides gate signals to the plurality of pixels, and a controller that controls the data driver and the gate driver.

The gate driver may be implemented as a shift register that includes a plurality of stages to sequentially provide the gate signals to the plurality of pixels on a row-by-row basis.

### SUMMARY

Some embodiments provide a gate driver in which each stage outputs two gate signals to two gate lines, respectively.

Some embodiments provide an electronic device including the gate driver.

According to embodiments, there is provided a gate driver including stages configured to receive a first carry clock signal, a second carry clock signal, a first clock signal, a second clock signal, a third clock signal, and a fourth clock signal, at least one stage of the stages including a logic circuit configured to control a voltage of a first node and a voltage of a second node based on the first carry clock signal and an input signal, a first transistor including a gate configured to receive a high gate voltage, a first terminal connected to the first node, and a second terminal connected to a third node, a second transistor including a gate configured to receive the high gate voltage, a first terminal connected to the first node, and a second terminal connected to a fourth node, a first gate output circuit configured to output a first gate signal to a first gate line based on the second clock signal, a voltage of the third node, and the voltage of the second node, a second gate output circuit configured to output a second gate signal to a second gate line that is different from the first gate line based on the third clock signal, a voltage of the fourth node, and the voltage of the second node, a carry output circuit configured to output a carry signal to a next stage based on the second carry clock signal, the voltage of the fourth node, and the voltage of the second node, and a first boosting capacitor connected between the fourth node and a carry output node for outputting the carry signal.

The first gate line may be connected to a first pixel row, wherein the second gate line is connected to a second pixel row below the first pixel row.

The second gate signal may be delayed by one horizontal time from the first gate signal.

The at least one stage may have no boosting capacitor connected to the third node.

The at least one stage may further include a second boosting capacitor connected between the third node and the first gate line, wherein a capacitance of the second boosting capacitor is less than a capacitance of the first boosting capacitor.

The second carry clock signal and the third clock signal may have rising edges at a same time point, wherein a falling edge of the second carry clock signal lags behind a falling edge of the third clock signal.

The first carry clock signal, the second carry clock signal, the first clock signal, the second clock signal, the third clock signal, and the fourth clock signal may have a pulse width corresponding to two horizontal times.

The first carry clock signal and the second carry clock signal may have a first pulse width corresponding to two horizontal times, wherein the first clock signal, the second clock signal, the third clock signal, and the fourth clock signal have a second pulse width that is shorter than the first pulse width.

The first gate output circuit may be configured to output the second clock signal as the first gate signal in response to the voltage of the third node, and is configured to output a low gate voltage as the first gate signal in response to the voltage of the second node, wherein the second gate output circuit is configured to output the third clock signal as the second gate signal in response to the voltage of the fourth node, and is configured to output the low gate voltage as the second gate signal in response to the voltage of the second node, and wherein the carry output circuit is configured to output the second carry clock signal as the carry signal in response to the voltage of the fourth node, and is configured to output another low gate voltage that is lower than the low gate voltage as the carry signal in response to the voltage of the second node.

The first gate output circuit may include a third transistor including a gate connected to the third node, a first terminal configured to receive the second clock signal, and a second terminal connected to the first gate line, and a fourth transistor including a gate connected to the second node, a first terminal connected to the first gate line, and a second terminal configured to receive a low gate voltage, wherein the second gate output circuit includes a fifth transistor including a gate connected to the fourth node, a first terminal configured to receive the third clock signal, and a second terminal connected to the second gate line, and a sixth transistor including a gate connected to the second node, a first terminal connected to the second gate line, and a second terminal configured to receive the low gate voltage, and wherein the carry output circuit includes a seventh transistor including a gate connected to the fourth node, a first terminal configured to receive the second carry clock signal, and a second terminal connected to the carry output node, and an eighth transistor including a gate connected to the second node, a first terminal connected to the carry output node, and a second terminal configured to receive another low gate voltage that is lower than the low gate voltage.

The logic circuit may include an input circuit configured to transfer the input signal to the first node in response to the first carry clock signal, and an inverter circuit configured to control the voltage of the second node based on the voltage of the third node.

The input circuit may include a ninth transistor including a gate configured to receive the first carry clock signal, a first terminal configured to receive the input signal, and a second terminal connected to the first node.

The inverter circuit may include a tenth transistor including a gate configured to receive the high gate voltage, a first terminal configured to receive the high gate voltage, and a second terminal, an eleventh transistor including a gate connected to the second terminal of the tenth transistor, a first terminal configured to receive the high gate voltage, and a second terminal connected to the second node, a capacitor including a first electrode connected to the gate of the eleventh transistor, and a second electrode connected to the second node, a twelfth transistor including a gate connected to the third node, a first terminal connected to the gate of the eleventh transistor, and a second terminal configured to receive a low gate voltage, and a thirteenth transistor including a gate connected to the third node, a first terminal connected to the second node, and a second terminal configured to receive another low gate voltage that is lower than the low gate voltage.

The logic circuit may further include a reset circuit configured to provide a low gate voltage to the first node in response to a reset signal, the reset circuit including a fourteenth transistor including a gate configured to receive the reset signal, a first terminal connected to the first node, and a second terminal configured to receive the low gate voltage.

A ninth transistor of the input circuit may include a first sub-transistor and a second sub-transistor that are connected in series, wherein the logic circuit further includes a leakage reduction circuit configured to provide the high gate voltage to a node between the first sub-transistor and the second sub-transistor in response to the voltage of the third node, the leakage reduction circuit including a fifteenth transistor including a gate connected to the third node, a first terminal configured to receive the high gate voltage, and a second terminal connected to the node between the first sub-transistor and the second sub-transistor.

The logic circuit may further include a stabilizing circuit configured to stabilize the voltage of the first node when the voltage of the second node has a high level, the stabilizing circuit including a sixteenth transistor including a gate configured to receive the second carry clock signal, a first terminal connected to the first node, and a second terminal, and a seventeenth transistor including a gate connected to the second node, a first terminal connected to the second terminal of the sixteenth transistor, and a second terminal connected to the carry output node.

According to embodiments, there is provided a gate driver including stages configured to receive a first carry clock signal, a second carry clock signal, a first clock signal, a second clock signal, a third clock signal, and a fourth clock signal, at least one stage of the stages including a logic circuit configured to control a voltage of a first node and a voltage of a second node based on the first carry clock signal and an input signal, a first transistor including a gate configured to receive a high gate voltage, a first terminal connected to the first node, and a second terminal connected to a third node, a second transistor including a gate configured to receive the high gate voltage, a first terminal connected to the first node, and a second terminal connected to a fourth node, a first gate output circuit configured to output a first gate signal to a first gate line based on the second clock signal, a voltage of the third node, and the voltage of the second node, a second gate output circuit configured to output a second gate signal to a second gate line that is different from the first gate line based on the third clock signal, a voltage of the fourth node, and the voltage of the second node, and a carry output circuit configured to output a carry signal to a next stage based on the second carry clock signal, the voltage of the fourth node, and the voltage of the second node, wherein the second carry clock signal and the third clock signal have rising edges at a same time point, and wherein a falling edge of the second carry clock signal lags behind a falling edge of the third clock signal.

The at least one stage may further include a boosting capacitor connected between the fourth node and a carry output node for outputting the carry signal.

According to embodiments, there is provided an electronic device including a processor, a memory connected to the processor, a power module connected to the processor, and a display device configured to receive input image data from the processor, and to display an image based on the input image data, the display device including a display panel including pixels, a data driver configured to provide data signals to the pixels, a gate driver configured to provide gate signals including a first gate signal and a second gate signal to the pixels, and a controller configured to control the data driver and the gate driver, wherein the gate driver includes stages configured to receive a first carry clock signal, a second carry clock signal, a first clock signal, a second clock signal, a third clock signal, and a fourth clock signal, at least one stage of the stages including a logic circuit configured to control a voltage of a first node and a voltage of a second node based on the first carry clock signal and an input signal, a first transistor including a gate configured to receive a high gate voltage, a first terminal connected to the first node, and a second terminal connected to a third node, a second transistor including a gate configured to receive the high gate voltage, a first terminal connected to the first node, and a second terminal connected to a fourth node, a first gate output circuit configured to output the first gate signal to a first gate line based on the second clock signal, a voltage of the third node, and the voltage of the second node, a second gate output circuit configured to output the second gate signal to a second gate line that is different from the first gate line based on the third clock signal, a voltage of the fourth node, and the voltage of the second node, a carry output circuit configured to output a carry signal to a next stage based on the second carry clock signal, the voltage of the fourth node, and the voltage of the second node, and a boosting capacitor connected between the fourth node and a carry output node for outputting the carry signal.

The second carry clock signal and the third clock signal may have rising edges at a same time point, wherein a falling edge of the second carry clock signal lags behind a falling edge of the third clock signal.

As described above, in a gate driver and an electronic device according to embodiments, a single stage may output first and second gate signals to first and second gate lines, respectively. Accordingly, the gate driver may have a small size, and a dead space area of a display device may be reduced.

Further, in the gate driver and the electronic device according to embodiments, each stage may include a boosting capacitor connected between a fourth node and a carry output node, and a falling edge of a second carry clock signal may lag behind a falling edge of a third clock signal. Accordingly, an output deviation between the first and second gate signals may be reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a gate driver according to embodiments.

FIG. 2 is a timing diagram for describing an operation of a gate driver of FIG. 1 according to embodiments.

FIG. 3 is a circuit diagram illustrating a stage of a gate driver according to embodiments.

FIG. 4 is a timing diagram for describing an operation of a stage of FIG. 3 according to embodiments.

FIG. 5 is a circuit diagram for describing an example of an operation of a stage of FIG. 3 in a first time period.

FIG. 6 is a circuit diagram for describing an example of an operation of a stage of FIG. 3 in a second time period.

FIG. 7 is a circuit diagram for describing an example of an operation of a stage of FIG. 3 in a third time period.

FIG. 8 is a circuit diagram for describing an example of an operation of a stage of FIG. 3 in a fourth time period.

FIG. 9 is a circuit diagram for describing an example of an operation of a stage of FIG. 3 in a fifth time period.

FIG. 10 is a timing diagram for describing an operation of a gate driver of FIG. 1 according to embodiments.

FIG. 11 is a timing diagram for describing an operation of a stage of FIG. 3 according to embodiments.

FIG. 12 is a circuit diagram for describing an example of an operation of a stage of FIG. 3 in a sixth time period.

FIG. 13 is a circuit diagram for describing an example of an operation of the stage of FIG. 3 in a seventh time period.

FIG. 14 is a circuit diagram illustrating a stage of a gate driver according to embodiments.

FIG. 15 is a block diagram illustrating a display device according to embodiments.

FIG. 16 is a block diagram illustrating an electronic device according to embodiments.

FIG. 17 is a schematic diagram of electronic devices according to various embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When "C to D" is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer, or section described below could be termed a second element, component, region, layer, or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/- 5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, 5% of the stated value. Further, the use of “may” when describing embodiments of the present disclosure refers to “one or more embodiments of the present disclosure.” Furthermore, the expression “being the same” may mean “being substantially the same.” In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

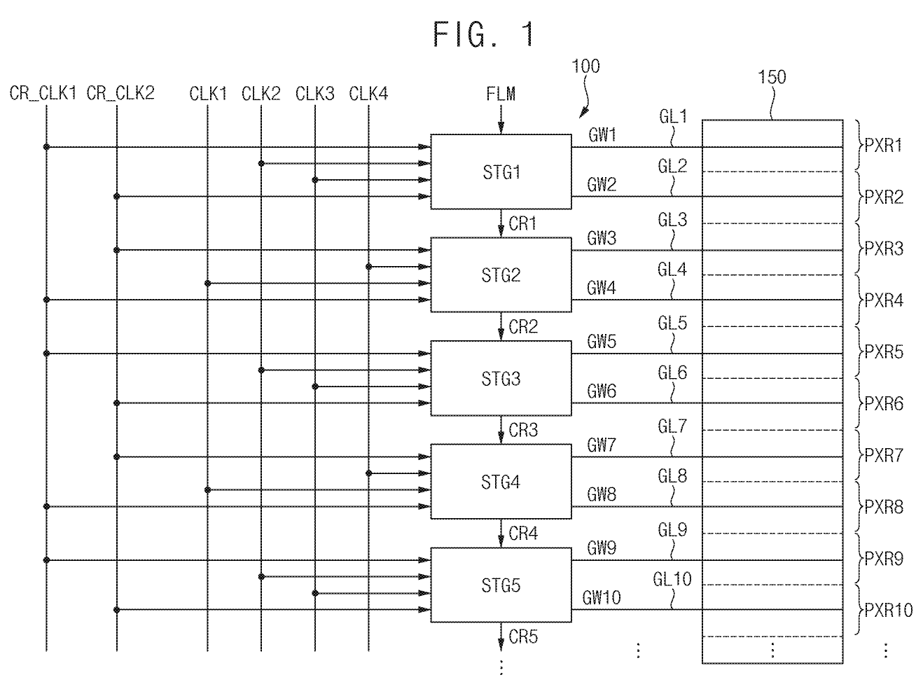

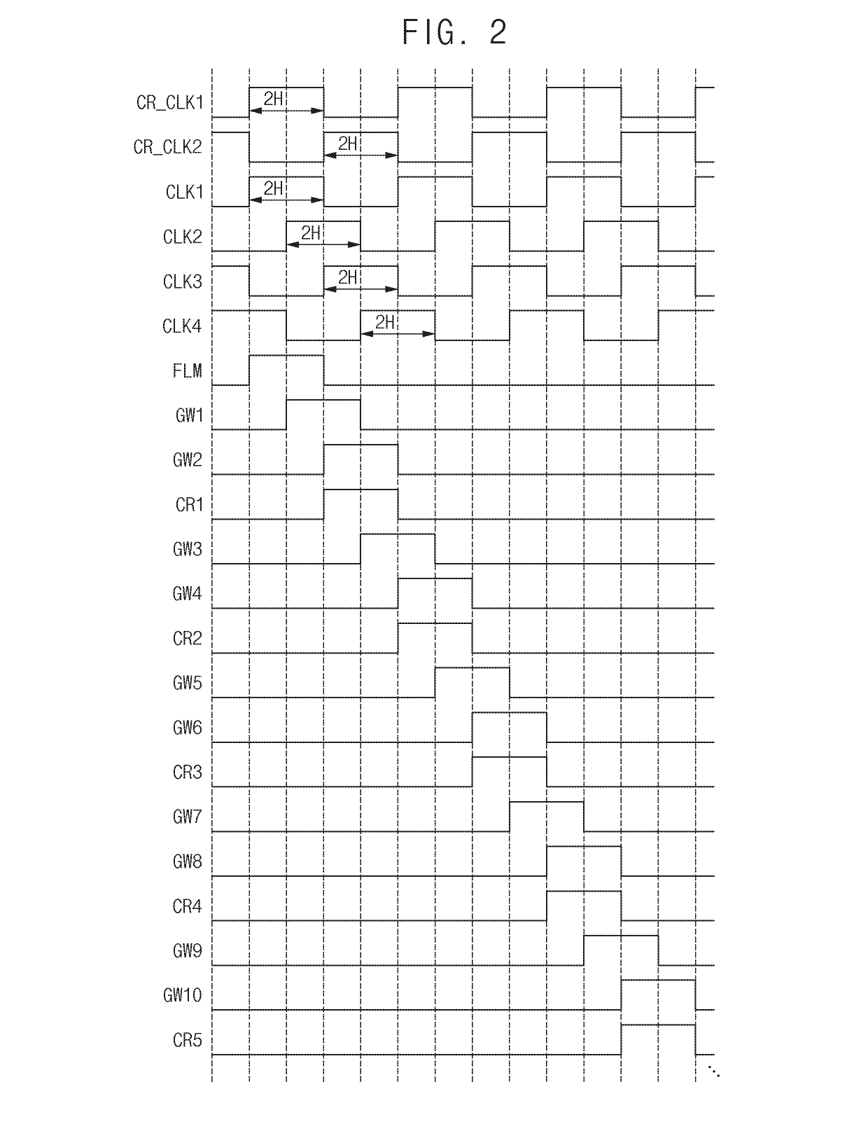

FIG. 1 is a block diagram illustrating a gate driver according to embodiments, and FIG. 2 is a timing diagram for describing an operation of a gate driver of FIG. 1 according to embodiments.

Referring to FIG. 1, a gate driver 100 according to embodiments may include a plurality of stages STG1, STG2, STG3, STG4, STG5, etc. In some embodiments, the gate driver 100 may be implemented as a shift register in which the plurality of stages STG1, STG2, STG3, STG4, STG5, etc. sequentially outputs gate signals GW1, GW2, GW3, GW4, GW5, GW6, GW7, GW8, GW9, GW10, etc.

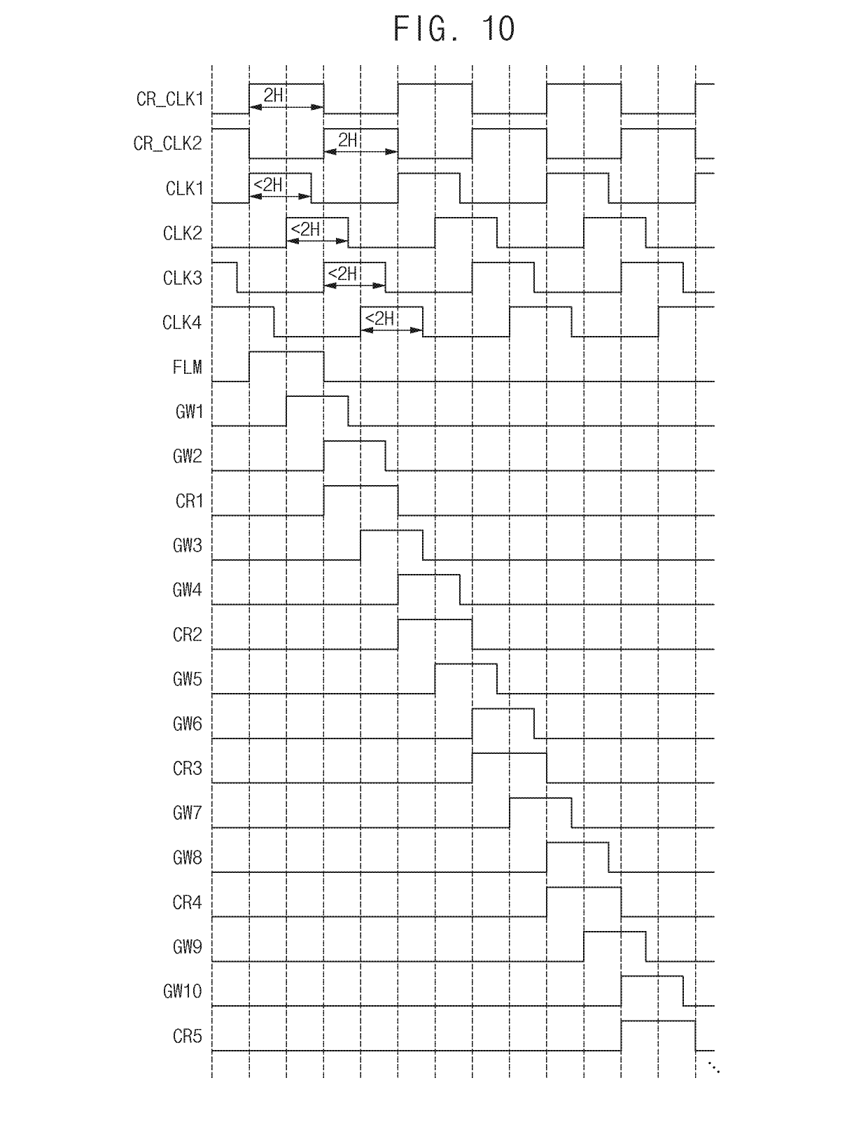

The plurality of stages STG1, STG2, STG3, STG4, STG5, etc. may receive a first carry clock signal CR_CLK1, a second carry clock signal CR_CLK2, a first clock signal CLK1, a second clock signal CLK2, a third clock signal CLK3, a fourth clock signal CLK4, and a start signal FLM. In some embodiments, as illustrated in FIG. 2, the first and second carry clock signals CR_CLK1 and CR_CLK2 may be shifted or delayed by two horizontal times 2H with respect to each other, and the first, second, third, and fourth clock signals CLK1, CLK2, CLK3, and CLK4 may be sequentially shifted or delayed by one horizontal time. Here, one horizontal time is a time allocated to one pixel row of a display panel 150, and may correspond to a time determined by dividing one frame period by the number of pixel rows PXR1, PXR2, PXR3, PXR4, PXR5, PXR6, PXR7, PXR8, PXR9, PXR10, etc. of the display panel 150. Further, in some embodiments, as illustrated in FIG. 2, each of the first carry clock signal CR_CLK1, the second carry clock signal CR_CLK2, the first clock signal CLK1, the second clock signal CLK2, the third clock signal CLK3, and the fourth clock signal CLK4 may have a pulse width corresponding to two horizontal times 2H. In other embodiments, as described below with reference to FIG. 10, each of the first and second carry clock signals CR_CLK1 and CR_CLK2 may have a first pulse width corresponding to two horizontal times 2H, and each of the first, second, third, and fourth clock signals CLK1, CLK2, CLK3, and CLK4 may have a second pulse width <2H, which is shorter than the first pulse width.

In the gate driver 100 according to embodiments, each stage (e.g., a first stage STG1) may output two gate signals (e.g., first and second gate signals GW1 and GW2) to two gate lines (e.g., first and second gate lines GL1 and GL2) connected to two pixel rows (e.g., first and second pixel rows PXR1 and PXR2) of the display panel 150, respectively.

For example, as illustrated in FIGS. 1 and 2, the first stage STG1 may receive the start signal FLM as an input signal based on the first carry clock signal CR_CLK1, may output the first gate signal GW1 to the first gate line GL1 for the first pixel row PXR1 based on the second clock signal CLK2, may output the second gate signal GW2 to the second gate line GL2 for the second pixel row PXR2 based on the third clock signal CLK3, and may output a first carry signal CR1 to a second stage STG2.

Further, the second stage STG2 may receive the first carry signal CR1 as an input signal based on the second carry clock signal CR_CLK2, may output a third gate signal GW3 to a third gate line GL3 for a third pixel row PXR3 based on the fourth clock signal CLK4, may output a fourth gate signal GW4 to a fourth gate line GL4 for a fourth pixel row PXR4 based on the first clock signal CLK1, and may output a second carry signal CR2 to a third stage STG3.

Further, the third stage STG3 may receive the second carry signal CR2 as an input signal based on the first carry clock signal CR_CLK1, may output a fifth gate signal GW5 to a fifth gate line GL5 for a fifth pixel row PXR5 based on the second clock signal CLK2, may output a sixth gate signal GW6 to a sixth gate line GL6 for a sixth pixel row PXR6 based on the third clock signal CLK3, and may output a third carry signal CR3 to a fourth stage STG4.

Further, the fourth stage STG4 may receive the third carry signal CR3 as an input signal based on the second carry clock signal CR_CLK2, may output a seventh gate signal GW7 to a seventh gate line GL7 for a seventh pixel row PXR7 based on the fourth clock signal CLK4, may output an eighth gate signal GW8 to an eighth gate line GL8 for an eighth pixel row PXR8 based on the first clock signal CLK1, and may output a fourth carry signal CR4 to a fifth stage STG5.

Further, the fifth stage STG5 may receive the fourth carry signal CR4 as an input signal based on the first carry clock signal CR_CLK1, may output a ninth gate signal GW9 to a ninth gate line GL9 for a ninth pixel row PXR9 based on the second clock signal CLK2, may output a tenth gate signal GW10 to a tenth gate line GL10 for a tenth pixel row PXR10 based on the third clock signal CLK3, and may output a fifth carry signal CR5 to a next stage.

In this manner, the plurality of stages STG1, STG2, STG3, STG4, STG5, etc. may sequentially output the carry signals CR1, CR2, CR3, CR4, CR5, etc. to next stages while shifting or delaying the carry signals CR1, CR2, CR3, CR4, CR5, etc. by two horizontal times 2H, and may sequentially output the gate signals GW1, GW2, GW3, GW4, GW5, GW6, GW7, GW8, GW9, GW10, etc. to the plurality of gate lines GL1, GL2, GL3, GL4, GL5, GL6, GL7, GL8, GL9, GL10, etc. for the plurality of pixel rows PXR1, PXR2, PXR3, PXR4, PXR5, PXR6, PXR7, PXR8, PXR9, PXR10, etc. while shifting or delaying the gate signals GW1, GW2, GW3, GW4, GW5, GW6, GW7, GW8, GW9, GW10, etc. by one horizontal time.

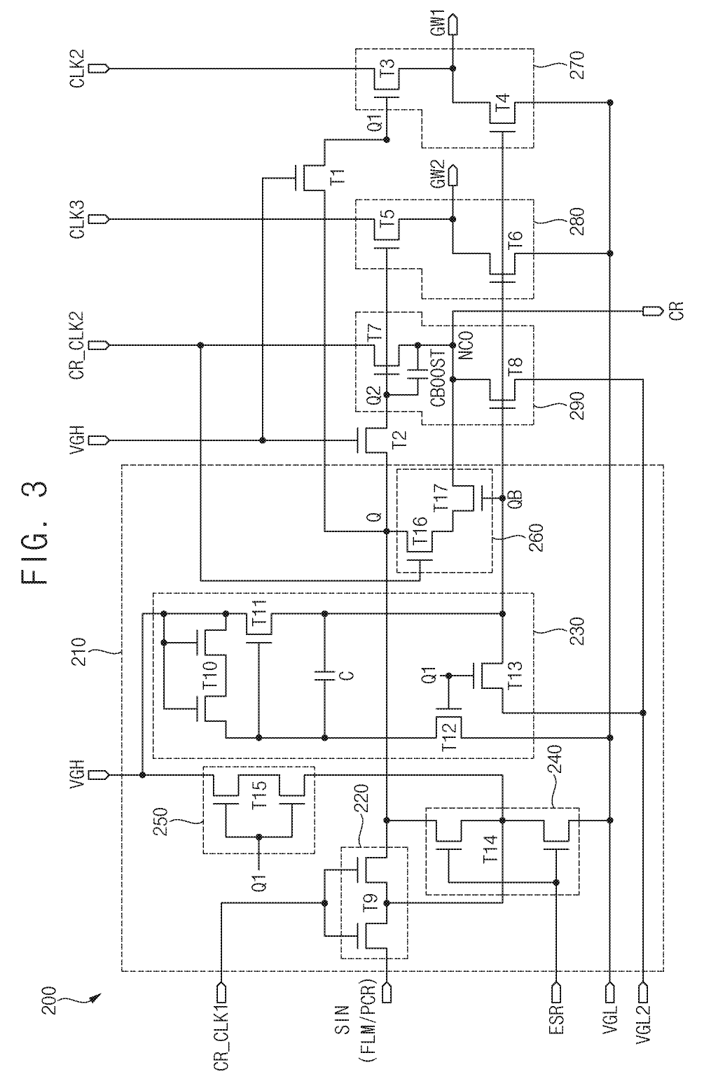

FIG. 3 is a circuit diagram illustrating a stage of a gate driver according to embodiments.

Referring to FIG. 3, at least one stage 200 of a driver according to embodiments may include a logic circuit 210, a first transistor T1, a second transistor T2, a first gate output circuit 270, a second gate output circuit 280, a carry output circuit 290 and a boosting capacitor CBOOST.

The logic circuit 210 may control a voltage of a first node Q and a voltage of a second node QB based on a first carry clock signal CR_CLK1 and an input signal SIN. In a case where the stage 200 is a first stage, the logic circuit 210 may receive a start signal FLM as the input signal SIN. Further, in a case where the stage 200 is one of subsequent stages, the logic circuit 210 may receive a carry signal PCR of a previous stage as the input signal SIN. The logic circuit 210 may include an input circuit 220 and an inverter circuit 230.

The input circuit 220 may transfer the input signal SIN to the first node Q in response to the first carry clock signal CR_CLK1. In some embodiments, the input circuit 220 may include a ninth transistor T9 including a gate that receives the first carry clock signal CR_CLK1, a first terminal that receives the input signal SIN, and a second terminal connected to the first node Q.

The inverter circuit 230 may control the voltage of the second node QB based on a voltage of a third node Q1 that is connected to the first node Q through the first transistor T1. For example, the inverter circuit 230 may provide a second low gate voltage VGL2 to the second node QB when the voltage of the third node Q1 has a high level, and may provide a high gate voltage VGH to the second node QB when the voltage of the third node Q1 has a low level. In some embodiments, the second low gate voltage VGL2 (or another low gate voltage) may be lower than a low gate voltage VGL for first and second gate signals GW1 and GW2.

In some embodiments, the inverter circuit 230 may include a tenth transistor T10, an eleventh transistor T11, a capacitor C, a twelfth transistor T12, and a thirteenth transistor T13. The tenth transistor T10 may include a gate that receives the high gate voltage VGH, a first terminal that receives the high gate voltage VGH, and a second terminal. The eleventh transistor T11 may include a gate connected to the second terminal of the tenth transistor T10, a first terminal that receives the high gate voltage VGH, and a second terminal connected to the second node QB. The capacitor C may include a first electrode connected to the gate of the eleventh transistor T11, and a second electrode connected to the second node QB. The twelfth transistor T12 may include a gate connected to the third node Q1, a first terminal connected to the gate of the eleventh transistor T11, and a second terminal that receives the low gate voltage VGL. The thirteenth transistor T13 may include a gate connected to the third node Q1, a first terminal connected to the second node QB, and a second terminal that receives the second low gate voltage VGL2. Although FIG. 3 illustrates an example in which the gates of the twelfth and thirteenth transistors T12 and T13 are connected to the third node Q1, in other embodiments, the gates of the twelfth and thirteenth transistors T12 and T13 may be connected to the first node Q or a fourth node Q2. In this case, the inverter circuit 230 may control the voltage of the second node QB based on the voltage of the first node Q or a voltage of the fourth node Q2.

In some embodiments, the logic circuit 210 may further include a reset circuit 240 that provides the low gate voltage VGL to the first node Q in response to a reset signal ESR. In some embodiments, the reset signal ESR may have a high level in an initial power-on period in which a display device is powered on, and the reset circuit 240 may provide the low gate voltage VGL to the first node Q in response to the reset signal ESR having the high level in the initial power-on period. Further, in some embodiments, the reset circuit 240 may include a fourteenth transistor T14 that includes a gate that receives the reset signal ESR, a first terminal connected to the first node Q, and a second terminal that receives the low gate voltage VGL.

In some embodiments, as illustrated in FIG. 3, each of the ninth and fourteenth transistors T9 and T14 may be implemented as a dual transistor including two sub-transistors connected in series to reduce a leakage current. In addition, to further reduce or prevent the leakage current, the logic circuit 210 may further include a leakage reduction circuit (e.g., a leakage prevention circuit) 250 that provides the high gate voltage VGH to a node between the two sub-transistors in response to the voltage of the third node Q1. In some embodiments, the leakage reduction circuit 250 may include a fifteenth transistor T15 that includes a gate connected to the third node Q1, a first terminal that receives the high gate voltage VGH, and a second terminal connected to the node between the two sub-transistors. Although FIG. 3 illustrates an example in which the gate of the fifteenth transistor T15 is connected to the third node Q1, in other embodiments, the gate of the fifteenth transistor T15 may be connected to the first node Q or to the fourth node Q2. In this case, the leakage reduction circuit 250 may provide the high gate voltage VGH to the node between the two sub-transistors in response to the voltage of the first node Q or the voltage of the fourth node Q2. Further, in some embodiments, as illustrated in FIG. 3, each of the tenth and fifteenth transistors T10 and T15 also may be implemented as a dual transistor.

In some embodiments, the logic circuit 210 may further include a stabilizing circuit 260 that stabilizes the voltage of the first node Q based on the second low gate voltage VGL2 when the voltage of the second node QB and a second carry clock signal CR_CLK2 have high levels. In some embodiments, the stabilizing circuit 260 may include a sixteenth transistor T16 that includes a gate that receives the second carry clock signal CR_CLK2, a first terminal connected to the first node Q, and a second terminal, and a seventeenth transistor T17 that includes a gate connected to the second node QB, a first terminal connected to the second terminal of the sixteenth transistor T16, and a second terminal connected to a carry output node NCO.

The first transistor T1 may be connected between the first node Q and the third node Q1, and may be turned on based on the high gate voltage VGH. Further, the second transistor T2 may be connected between the first node Q and the fourth node Q2, and may be turned on based on the high gate voltage VGH. In some embodiments, the first transistor T1 may be turned on to connect the first node Q and the third node Q1 to each other in most periods, the second transistor T2 may be turned on to connect the first node Q and the fourth node Q2 to each other in most periods, and thus each of the first and second transistors T1 and T2 may be referred to as an always-on transistor (“AOT”). Further, the first transistor T1 may reduce or prevent transfer of the voltage of the third node Q1 to the first node Q when the voltage of the third node Q1 is boosted, and the second transistor T2 may reduce or prevent transfer of the voltage of the fourth node Q2 to the first node Q when the voltage of the fourth node Q2 is boosted. In some embodiments, the first transistor T1 may include a gate that receives the high gate voltage VGH, a first terminal connected to the first node Q, and a second terminal connected to the third node Q1, and the second transistor T2 may include a gate that receives the high gate voltage VGH, a first terminal connected to the first node Q, and a second terminal connected to the fourth node Q2.

The first gate output circuit 270 may output a first gate signal GW1 to a first gate line based on a second clock signal CLK2, the voltage of the third node Q1, the voltage of the second node QB and the low gate voltage VGL. The first gate output circuit 270 may output the second clock signal CLK2 as the first gate signal GW1 in response to the voltage of the third node Q1, and may output the low gate voltage VGL as the first gate signal GW1 in response to the voltage of the second node QB. In some embodiments, the first gate output circuit 270 may include a third transistor T3 that include a gate connected to the third node Q1, a first terminal that receives the second clock signal CLK2, and a second terminal connected to the first gate line, and a fourth transistor T4 that includes a gate connected to the second node QB, a first terminal connected to the first gate line, and a second terminal that receives the low gate voltage VGL.

The second gate output circuit 280 may output a second gate signal GW2 to a second gate line different from the first gate line based on a third clock signal CLK3, the voltage of the fourth node Q2, the voltage of the second node QB and the low gate voltage VGL. The second gate output circuit 280 may output the third clock signal CLK3 as the second gate signal GW2 in response to the voltage of the fourth node Q2, and may output the low gate voltage VGL as the second gate signal GW2 in response to the voltage of the second node QB. In some embodiments, the second gate output circuit 280 may include a fifth transistor T5 that includes a gate connected to the fourth node Q2, a first terminal that receives the third clock signal CLK3, and a second terminal connected to the second gate line, and a sixth transistor T6 that includes a gate connected to the second node QB, a first terminal connected to the second gate line, and a second terminal that receives the low gate voltage VGL.

The stage 200 may output two gate signals GW1 and GW2 to two gate lines for two pixel rows, respectively. For example, the first gate line may be a gate line connected to a first pixel row, the second gate line may be a gate line connected to the second pixel row below the first pixel row, and the stage 200 may provide the first and second gate signals GW1 and GW2 to the first and second pixel rows through the first and second gate lines, respectively. Further, in some embodiments, the third clock signal CLK3 may be delayed by one horizontal time from the second clock signal CLK2, and thus the second gate signal GW2 that is output to the second gate line may be delayed by one horizontal time from the first gate signal GW1 that is output to the first gate line.

The carry output circuit 290 may output a carry signal CR to a next stage based on the second carry clock signal CR_CLK2, the voltage of the fourth node Q2, the voltage of the second node QB and the second low gate voltage VGL2. The carry output circuit 290 may output the second carry clock signal CR_CLK2 as the carry signal CR in response to the voltage of the fourth node Q2, and may output the second low gate voltage VGL2 lower than the low gate voltage VGL as the carry signal CR in response to the voltage of the second node QB. In some embodiments, the carry output circuit 290 may include a seventh transistor T7 that includes a gate connected to the fourth node Q2, a first terminal that receives the second carry clock signal CR_CLK2, and a second terminal connected to the carry output node NCO from which the carry signal CR is output, and an eighth transistor T8 that includes a gate connected to the second node QB, a first terminal connected to the carry output node NCO, and a second terminal that receives the second low gate voltage VGL2.

The stage 200 (or the carry output circuit 290 of the stage 200) according to embodiments may include the boosting capacitor CBOOST connected between the fourth node Q2 and the carry output node NCO. In some embodiments, the boosting capacitor CBOOST may include a first electrode connected to the fourth node Q2, and a second electrode connected to the carry output node NCO. In some embodiments, as illustrated in FIG. 3, the stage 200 may have no boosting capacitor directly connected to the third node Q1. That is, any boosting capacitor may not be connected to the third node Q1 (e.g., may be omitted) for the first gate signal GW1 that is first output, and the boosting capacitor CBOOST may be connected to the fourth node Q2 for the second gate signal GW2 that is subsequently output. Thus, due to the boosting capacitor CBOOST, a charge storage capacity at the fourth node Q2 for the second gate signal GW2 that is subsequently output may be greater than a charge storage capacity at the third node Q1 for the first gate signal GW1 that is first output. Accordingly, an undesired voltage decrease of the fourth node Q2 due to a leakage current (e.g., a leakage current through the first and second transistors T1 and T2) when the voltage of the third node Q1 decreases may be reduced, and an output deviation (or a falling delay deviation) between the first and second gate signals GW1 and GW2 may be reduced.

In some embodiments, as illustrated in FIG. 3, the first through seventeenth transistors T1 through T17 included in the stage 200 may be, but are not limited to, N-type metal-oxide-semiconductor (“NMOS”) transistors. Further, in some embodiments, the first through seventeenth transistors T1 through T17 included in the stage 200 may be, but are not limited to, oxide transistors including an active region having an oxide semiconductor.

As described above, in the gate driver according to embodiments, the single stage 200 may output the first and second gate signals GW1 and GW2 to the first and second gate lines connected to the first and second pixel rows, respectively. Accordingly, the gate driver may have a relatively small size, and a dead space area of the display device including the gate driver may be reduced. Further, in the gate driver according to embodiments, the stage 200 may include the boosting capacitor CBOOST connected between the carry output node NCO and the fourth node Q2 for the second gate signal GW2 that is subsequently output. Accordingly, an undesired voltage decrease of the fourth node Q2 due to the leakage current (e.g., the leakage current through the first and second transistors T1 and T2) when the voltage of the third node Q1 decreases may be reduced, and the output deviation (or the falling delay deviation) between the first and second gate signals GW1 and GW2 may be reduced.

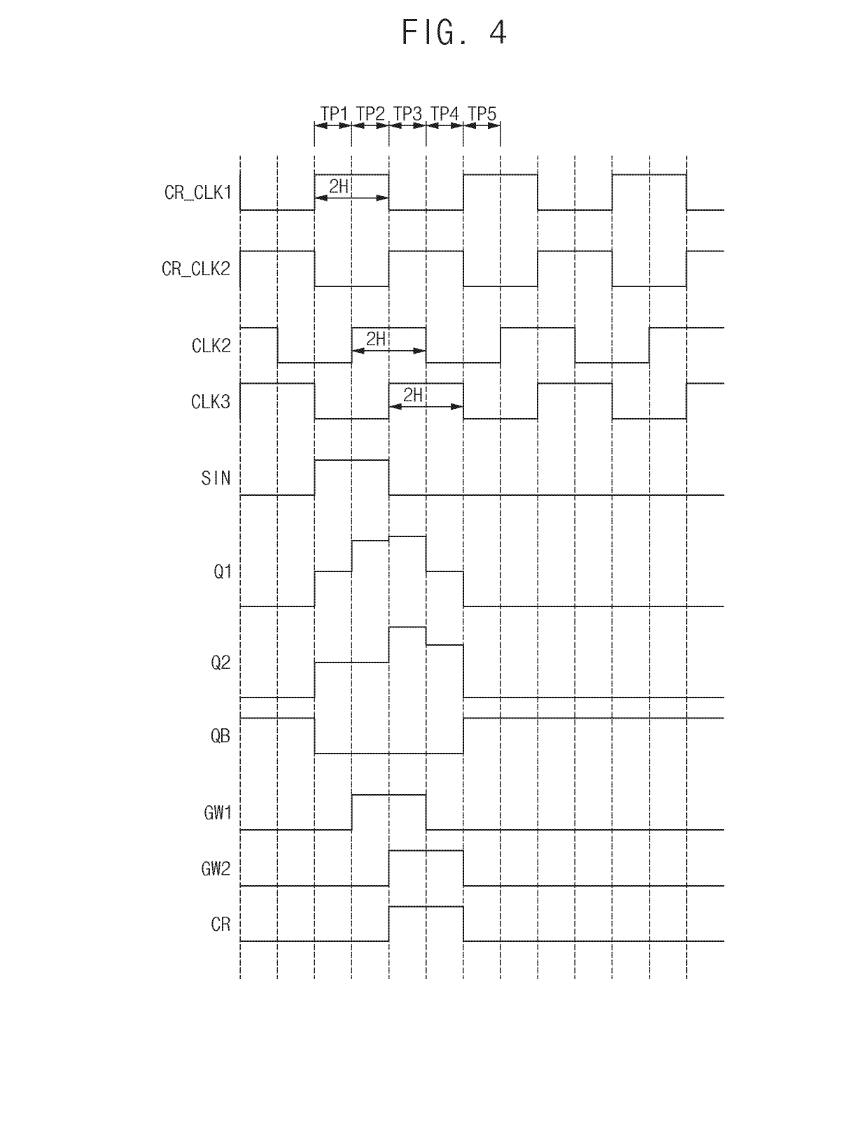

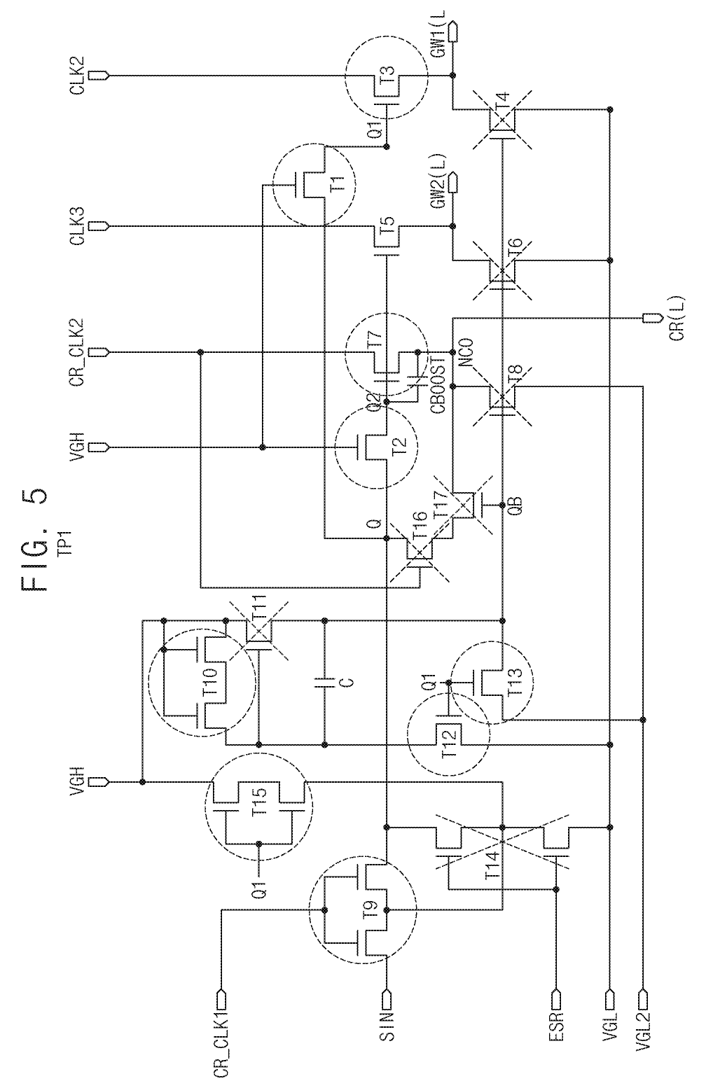

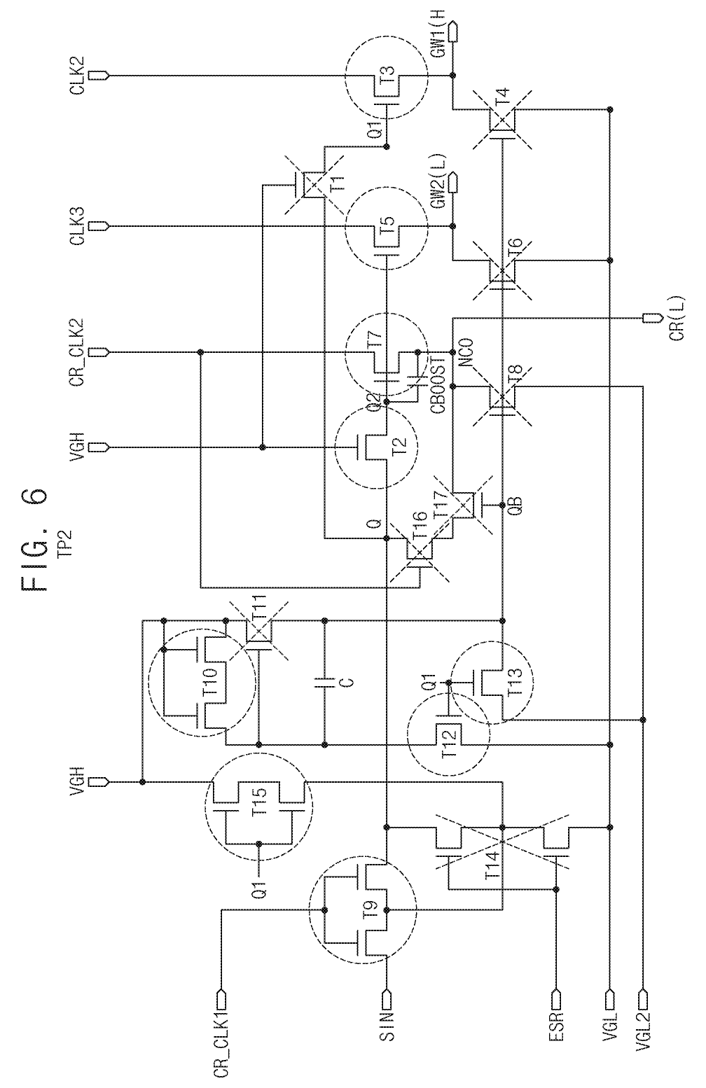

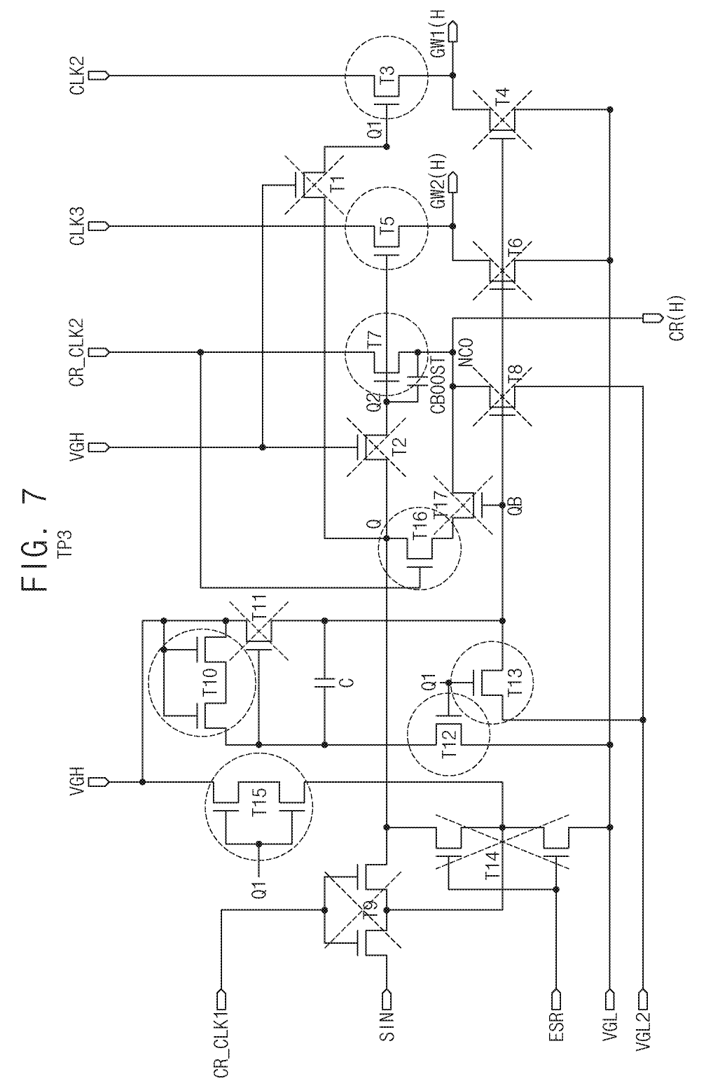

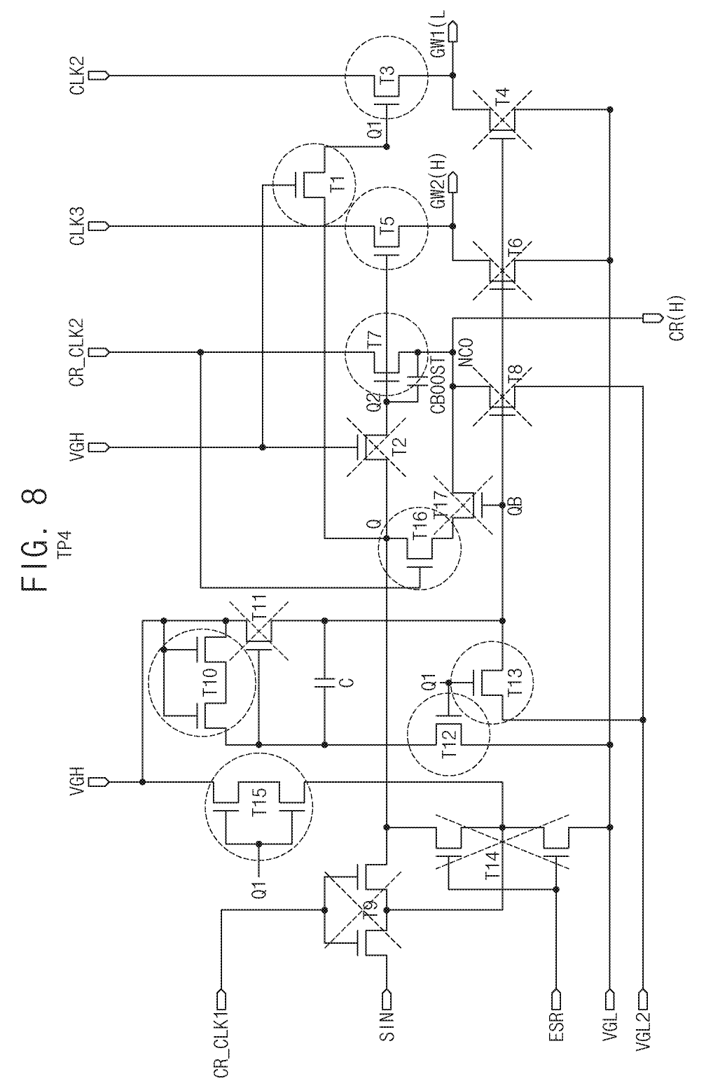

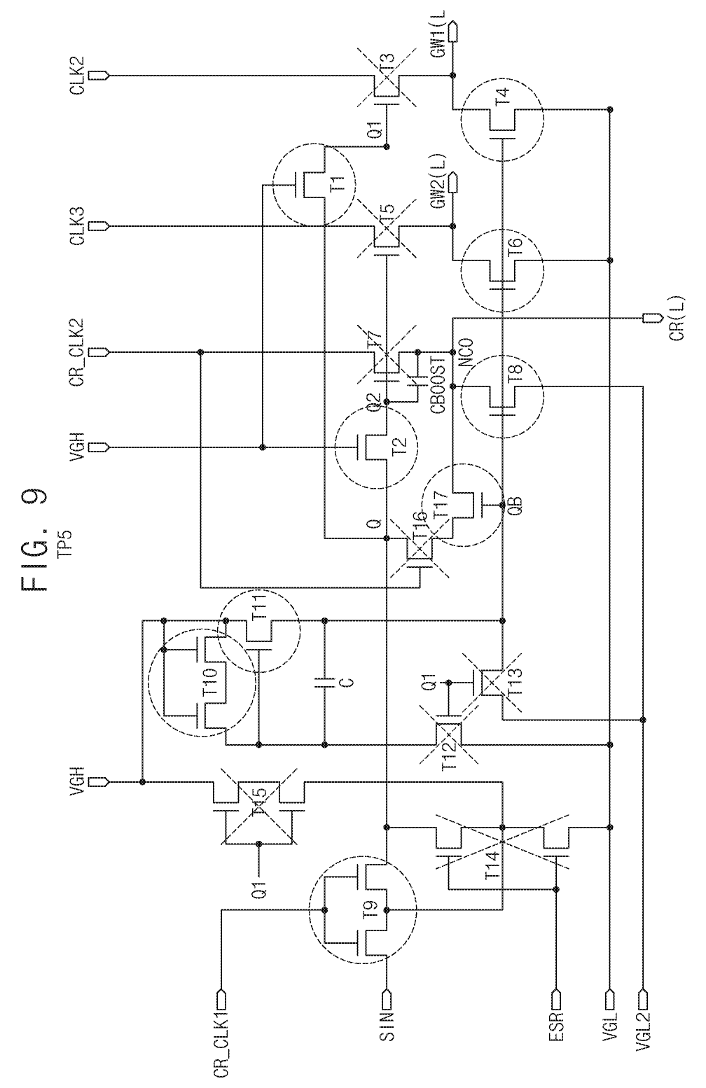

FIG. 4 is a timing diagram for describing an operation of a stage of FIG. 3 according to embodiments, FIG. 5 is a circuit diagram for describing an example of an operation of a stage of FIG. 3 in a first time period, FIG. 6 is a circuit diagram for describing an example of an operation of a stage of FIG. 3 in a second time period, FIG. 7 is a circuit diagram for describing an example of an operation of a stage of FIG. 3 in a third time period, FIG. 8 is a circuit diagram for describing an example of an operation of a stage of FIG. 3 in a fourth time period, and FIG. 9 is a circuit diagram for describing an example of an operation of a stage of FIG. 3 in a fifth time period.

Referring to FIGS. 3 and 4, the stage 200 may receive the input signal SIN in response to the first carry clock signal CR_CLK1. The stage 200 may output the first gate signal GW1 having the high level to the first gate line when the second clock signal CLK2 becomes the high level after the input signal SIN becomes the high level. Thereafter, when the third clock signal CLK3 and the second carry clock signal CR_CLK2 become the high levels, the stage 200 may output the second gate signal GW2 having the high level to the second gate line, and may output the carry signal CR having the high level to the next stage. In some embodiments, as illustrated in FIG. 4, each of the first and second carry clock signals CR_CLK1 and CR_CLK2 and each of the second and third clock signals CLK2 and CLK3 may have the pulse width corresponding to two horizontal times 2H.

For example, in a first time period TP1 in which the input signal SIN has the high level and the first carry clock signal CR_CLK1 has the high level, as illustrated in FIG. 5, the ninth transistor T9 may be turned on in response to the first carry clock signal CR_CLK1, and may transfer the input signal SIN having the high level to the first node Q. Thus, the voltage of the first node Q may have the high level, and the voltages of the third and fourth nodes Q1 and Q2, which are connected to the first node Q through the first and second transistors T1 and T2, respectively, also may have the high levels. The third, twelfth, thirteenth and fifteenth transistors T3, T12, T13, and T15 may be turned on in response to the voltage of the third node Q1. The third transistor T3 may output the first gate signal GW1 having the low level L based on the second clock signal CLK2 having the low level. Further, the fifth and seventh transistors T5 and T7 may be turned on in response to the voltage of the fourth node Q2, the fifth transistor T5 may output the second gate signal GW2 having the low level L based on the third clock signal CLK3 having the low level, and the seventh transistor T7 may output the carry signal CR having the low level L based on the second carry clock signal CR_CLK2 having the low level. The thirteenth transistor T13 may transfer the second low gate voltage VGL2 to the second node QB, and the fourth, sixth, eighth and seventeenth transistors T4, T6, T8 and T17 may be turned off in response to the voltage of the second node QB. The fifteenth transistor T15 may provide the high gate voltage VGH to the node between the sub-transistors of each of the ninth transistor T9 and the fourteenth transistor T14. The tenth transistor T10 may be turned on based on the high gate voltage VGH to transfer the high gate voltage VGH to the gate of the eleventh transistor T11, and the twelfth transistor T12 may transfer the low gate voltage VGL to the gate of the eleventh transistor T11. Thus, a voltage between the high gate voltage VGH and the low gate voltage VGL may be applied to the gate of the eleventh transistor T11, and the eleventh transistor T11 may be turned off. Further, the sixteenth transistor T16 may be turned off in response to the second carry clock signal CR_CLK2.

In a second time period TP2 in which the second clock signal CLK2 has the high level, as illustrated in FIG. 6, the third transistor T3 may output the first gate signal GW1 having the high level H based on the second clock signal CLK2 having the high level. Although the stage 200 has no boosting capacitor directly connected to the third node Q1, the third transistor T3 may have a parasitic capacitor between the gate and one terminal (e.g., a source) of the third transistor T3, and the voltage of the third node Q1 may be boosted by the parasitic capacitor of the third transistor T3 when the second clock signal CLK2 changes from the low level to the high level. When the voltage of the third node Q1 is boosted, because the high gate voltage VGH applied to the gate of the first transistor T1 is lower than the voltage of the third node Q1, the first transistor T1 may be turned off, and transfer of the voltage of the third node Q1 to the first node Q may be reduced or prevented. The fifth transistor T5 may output the second gate signal GW2 having the low level L based on the third clock signal CLK3 having the low level, and the seventh transistor T7 may output the carry signal CR having the low level L based on the second carry clock signal CR_CLK2 having the low level. Further, the second, ninth, tenth, twelfth, thirteenth, and fifteenth transistors T2, T9, T10, T12, T13, and T15 may be turned on, and the fourth, sixth, eighth, eleventh, fourteenth, sixteenth, and seventeenth transistors T4, T6, T8, T11, T14, T16, and T17 may be turned off.

In a third time period TP3 in which the third clock signal CLK3 and the second carry clock signal CR_CLK2 have the high levels, as illustrated in FIG. 7, the fifth transistor T5 may output the second gate signal GW2 having the high level H based on the third clock signal CLK3 having the high level, and the seventh transistor T7 may output the carry signal CR having the high level H based on the second carry clock signal CR_CLK2 having the high level. When the second carry clock signal CR_CLK2 changes from the low level to the high level, the voltage of the fourth node Q2 may be boosted by the boosting capacitor CBOOST. When the voltage of the fourth node Q2 is boosted, because the high gate voltage VGH applied to the gate of the second transistor T2 is lower than the voltage of the fourth node Q2, the second transistor T2 may be turned off, and transfer of the voltage of the fourth node Q2 to the first node Q may be reduced or prevented. The third transistor T3 may output the first gate signal GW1 having the high level H based on the second clock signal CLK2 having the high level. Further, the tenth, twelfth, thirteenth, fifteenth, and sixteenth transistors T10, T12, T13, T15, and T16 may be turned on, and the first, fourth, sixth, eighth, ninth, eleventh, fourteenth, and seventeenth transistors T1, T4, T6, T8, T9, T11, T14, and T17 may be turned off.

In a fourth time period TP4 in which the second clock signal CLK2 has the low level, as illustrated in FIG. 8, the third transistor T3 may output the first gate signal GW1 having the low level L based on the second clock signal CLK2 having the low level. When the second clock signal CLK2 changes from the high level to the low level, the voltage of the third node Q1 also may be decreased (e.g., from a boosted high level to the high level) by the parasitic capacitor of the third transistor T3. Even if the voltage of the third node Q1 is decreased, because the charge storage capacity at the fourth node Q2 is greater than the charge storage capacity at the third node Q1 due to the boosting capacitor CBOOST, a voltage decrease amount of the fourth node Q2 caused by the leakage current of the second transistor T2 may be less than a voltage decrease amount of the third node Q1. Thus, the fifth transistor T5 may output the second gate signal GW2 having the high level H based on the third clock signal CLK3 having the high level, and the seventh transistor T7 may output the carry signal CR having the high level H based on the second carry clock signal CR_CLK2 having the high level. Further, the first, tenth, twelfth, thirteenth, fifteenth, and sixteenth transistors T1, T10, T12, T13, T15, and T16 may be turned on, and the second, fourth, sixth, eighth, ninth, eleventh, fourteenth, and seventeenth transistors T2, T4, T6, T8, T9, T11, T14, and T17 may be turned off.

In a fifth time period TP5 in which the input signal SIN has the low level and the first carry clock signal CR_CLK1 has the high level, as illustrated in FIG. 9, the ninth transistor T9 may be turned on in response to the first carry clock signal CR_CLK1, and may transfer the input signal SIN having the low level to the first node Q. Thus, the voltage of the first node Q may have the low level, and the voltages of the third and fourth nodes Q1 and Q2, which are connected to the first node Q through the first and second transistors T1 and T2, respectively, also may have the low levels. The twelfth and thirteenth transistors T12 and T13 may be turned off in response to the voltage of the third node Q1, and the tenth transistor T10 may be turned on based on the high gate voltage VGH to transfer the high gate voltage VGH to the gate of the eleventh transistor T11. Thus, the eleventh transistor T11 may be turned on in response to the high gate voltage VGH transferred by the tenth transistor T10, and may transfer the high gate voltage VGH to the second node QB. The fourth, sixth, eighth, and seventeenth transistors T4, T6, T8, and T17 may be turned on in response to the voltage of the second node QB. The fourth transistor T4 may output the first gate signal GW1 having the low level L based on the low gate voltage VGL, the sixth transistor T6 may output the second gate signal GW2 having the low level L based on the low gate voltage VGL, and the eighth transistor T8 may output the carry signal CR having the low level L based on the second low gate voltage VGL2. Further, the third, fifth, seventh, fourteenth, fifteenth, and sixteenth transistors T3, T5, T7, T14, T15, and T16 may be turned off.

FIG. 10 is a timing diagram for describing an operation of a gate driver of FIG. 1 according to embodiments.

Referring to FIGS. 1 and 10, a plurality of stages STG1, STG2, STG3, STG4, STG5, etc. may receive first and second carry clock signals CR_CLK1 and CR_CLK2, first, second, third, and fourth clock signals CLK1, CLK2, CLK3, and CLK4, and a start signal FLM, may sequentially output carry signals CR1, CR2, CR3, CR4, CR5, etc. to next stages while shifting or delaying the carry signals CR1, CR2, CR3, CR4, CR5, etc. by two horizontal times 2H, and may sequentially output gate signals GW1, GW2, GW3, GW4, GW5, GW6, GW7, GW8, GW9, GW10, etc. to a plurality of gate lines GL1, GL2, GL3, GL4, GL5, GL6, GL7, GL8, GL9, GL10, etc. of a plurality of pixel rows PXR1, PXR2, PXR3, PXR4, PXR5, PXR6, PXR7, PXR8, PXR9, PXR10, etc. while shifting or delaying the gate signals GW1, GW2, GW3, GW4, GW5, GW6, GW7, GW8, GW9, GW10, etc. by one horizontal time.

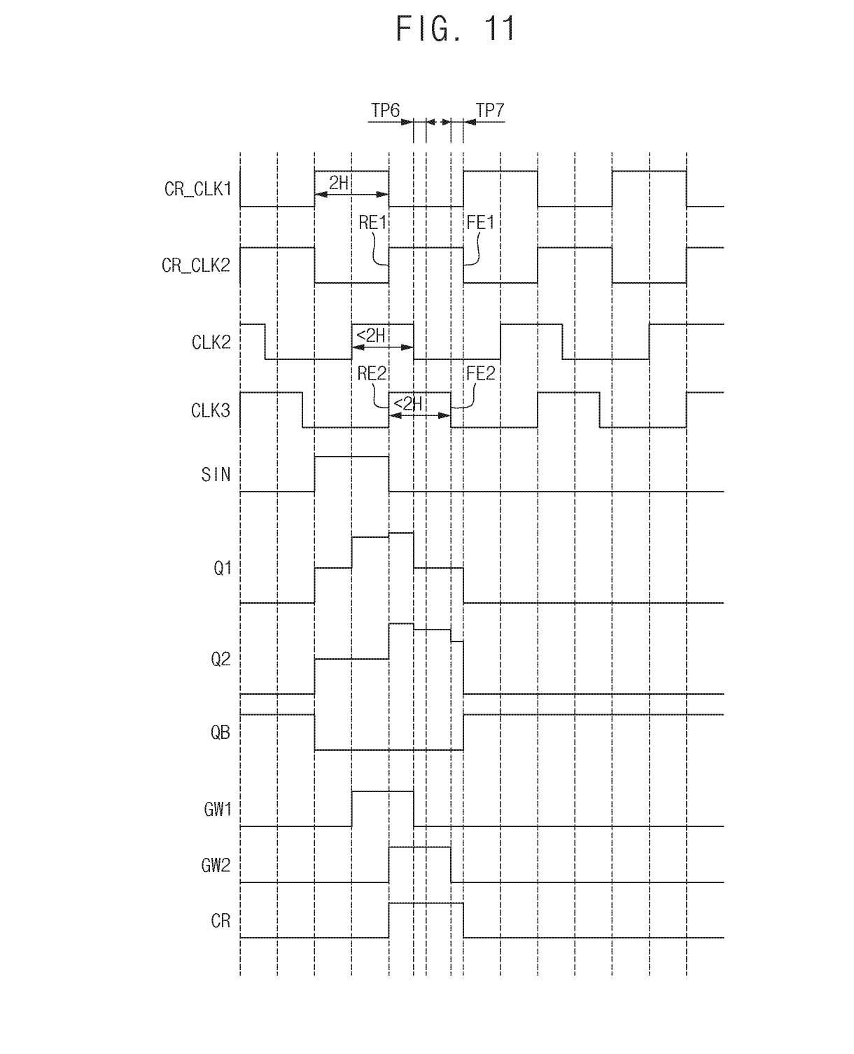

In some embodiments, as illustrated in FIG. 10, each of the first and second carry clock signals CR_CLK1 and CR_CLK2 may have a first pulse width corresponding to two horizontal times 2H, and each of the first, second, third, and fourth clock signals CLK1, CLK2, CLK3, and CLK4 may have a second pulse width <2H shorter than the first pulse width. Accordingly, as described below with reference to FIGS. 11 to 13, a falling edge FE1 of the second carry clock signal CR_CLK2 may lag behind a falling edge FE2 of the third clock signal CLK3, and an output deviation (e.g., a falling delay deviation) between gate signals (e.g., first and second gate signals GW1 and GW2) output from the same stage (e.g., a first stage STG1) may be reduced.

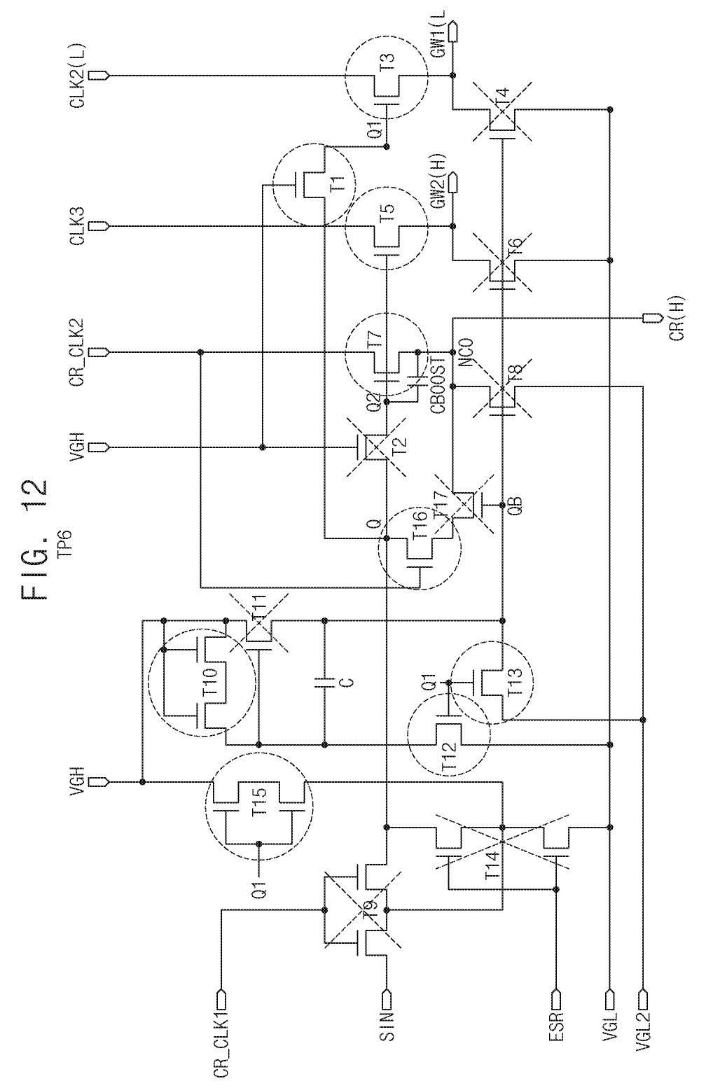

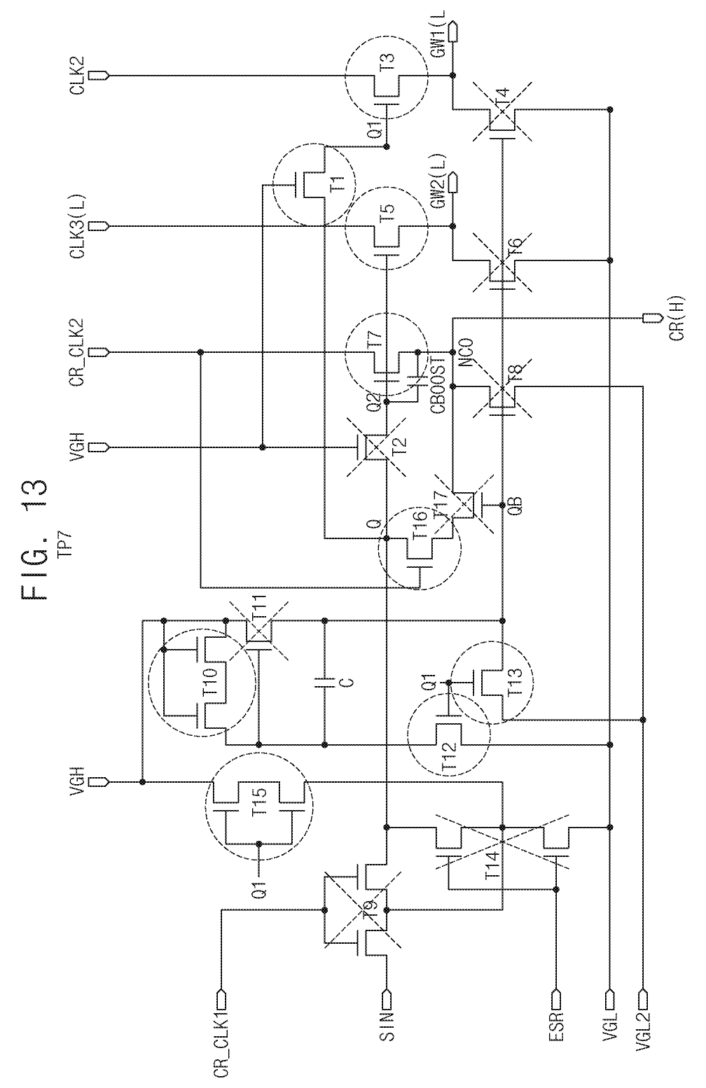

FIG. 11 is a timing diagram for describing an operation of a stage of FIG. 3 according to embodiments, FIG. 12 is a circuit diagram for describing an example of an operation of a stage of FIG. 3 in a sixth time period, and FIG. 13 is a circuit diagram for describing an example of an operation of the stage of FIG. 3 in a seventh time period.

Referring to FIGS. 3 and 11, the stage 200 may receive the first and second carry clock signals CR_CLK1 and CR_CLK2 having the first pulse width corresponding to two horizontal times 2H, and may receive the second and third clock signals CLK2 and CLK3 having the second pulse width <2H, which is shorter than the first pulse width. In some embodiments, as illustrated in FIG. 11, the second carry clock signal CR_CLK2 and the third clock signal CLK3 may respectively have rising edges RE1 and RE2 at substantially the same time point, and the falling edge FE1 of the second carry clock signal CR_CLK2 may lag behind the falling edge FE2 of the third clock signal CLK3. Accordingly, the voltage of the fourth node Q2 may have a high level (or a level higher than the high gate voltage VGH) at a time point when the second gate signal GW2 changes from a high level to a low level, and a falling delay time of the second gate signal GW2 may be reduced, and the falling delay deviation between the first and second gate signals GW1 and GW2 may be reduced.

For example, in a sixth time period TP6 in which the second clock signal CLK2 changes from the high level to the low level, as illustrated in FIG. 12, a third transistor T3 may output a first gate signal GW1 having the low level L based on the second clock signal CLK2 having the low level L. When the second clock signal CLK2 changes from the high level to the low level L, a voltage of a third node Q1 also may be decreased (e.g., from a boosted high level to the high level) due to a parasitic capacitor of the third transistor T3. Even if the voltage of the third node Q1 is decreased, because a charge storage capacity at a fourth node Q2 may be greater than a charge storage capacity at the third node Q1 due to a boosting capacitor CBOOST, a voltage decrease amount of the fourth node Q2 caused by a leakage current of a second transistor T2 may be less than a voltage decrease amount of the third node Q1. Thus, a fifth transistor T5 may output a second gate signal GW2 having the high level H based on the third clock signal CLK3 having the high level, and a seventh transistor T7 may output a carry signal CR having the high level H based on the second carry clock signal CR_CLK2 having the high level.

Thereafter, in a seventh time period TP7 in which the third clock signal CLK3 changes from the high level to the low level, the second carry clock signal CR_CLK2 may have the high level, and the voltage of the fourth node Q2 may have the high level (or the level that is higher than the high gate voltage VGH). Thus, as illustrated in FIG. 13, the fifth transistor T5 may output the second gate signal GW2 having the low level L based on the third clock signal CLK3 having the low level L, and the seventh transistor T7 may output the carry signal CR having the high level H based on the second carry clock signal CR_CLK2 having the high level. Because the second gate signal GW2 decreases from the high level to the low level while the voltage of the fourth node Q2 has the high level (or the level higher than the high gate voltage VGH), the falling delay time of the second gate signal GW2 may be reduced, and the falling delay deviation between the first and second gate signals GW1 and GW2 may be reduced.

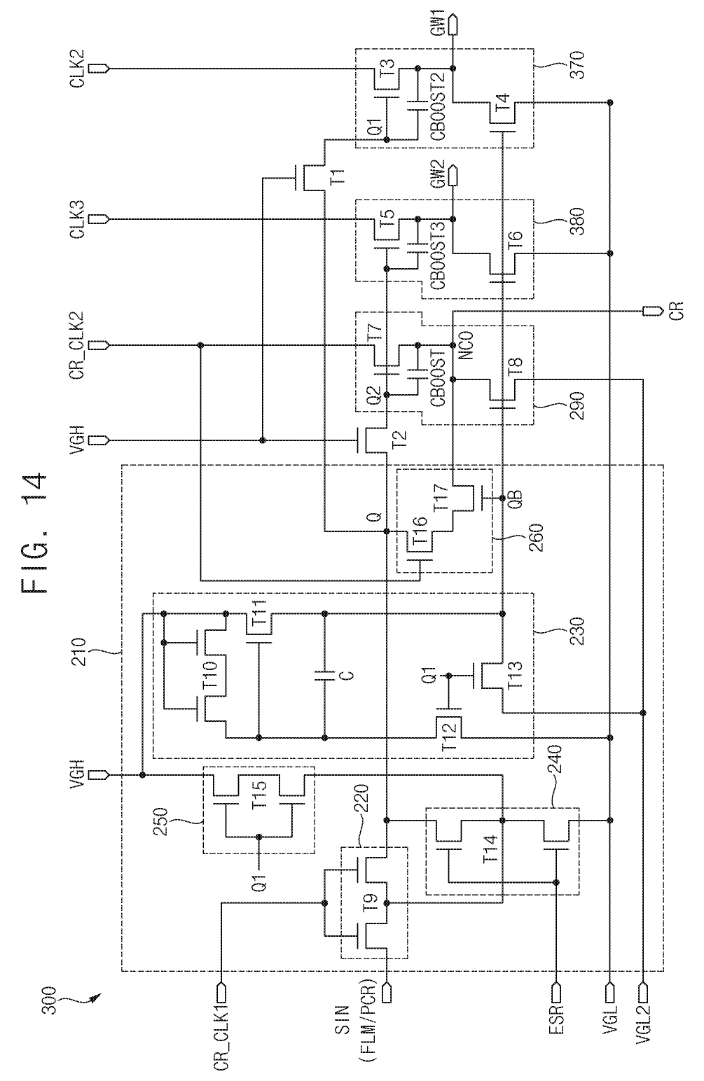

FIG. 14 is a circuit diagram illustrating a stage of a gate driver according to embodiments.

Referring to FIG. 14, a stage 300 may include a logic circuit 210, a first transistor T1, a second transistor T2, a first gate output circuit 370, a second gate output circuit 380, a carry output circuit 290, and a boosting capacitor CBOOST (or a first boosting capacitor CBOOST). In some embodiments, the stage 300 may further include a second boosting capacitor CBOOST2 connected between a third node Q1 and a first gate line, and/or a third boosting capacitor CBOOST3 connected between a fourth node Q2 and a second gate line. The stage 300 may have substantially the same configuration and substantially the same operation as a stage 200 of FIG. 3, except that the stage 300 may further include the second boosting capacitor CBOOST2 and/or the third boosting capacitor CBOOST3.

In some embodiments, a capacitance of the second boosting capacitor CBOOST2 connected to the third node Q1 may be less than a capacitance of the boosting capacitor CBOOST connected to the fourth node Q2. Accordingly, a charge storage capacity at the fourth node Q2 for a second gate signal GW2 that is subsequently output may be greater than a charge storage capacity at the third node Q1 for a first gate signal GW1 that is first output, and an output deviation (or a falling delay deviation) between the first and second gate signals GW1 and GW2 may be reduced.

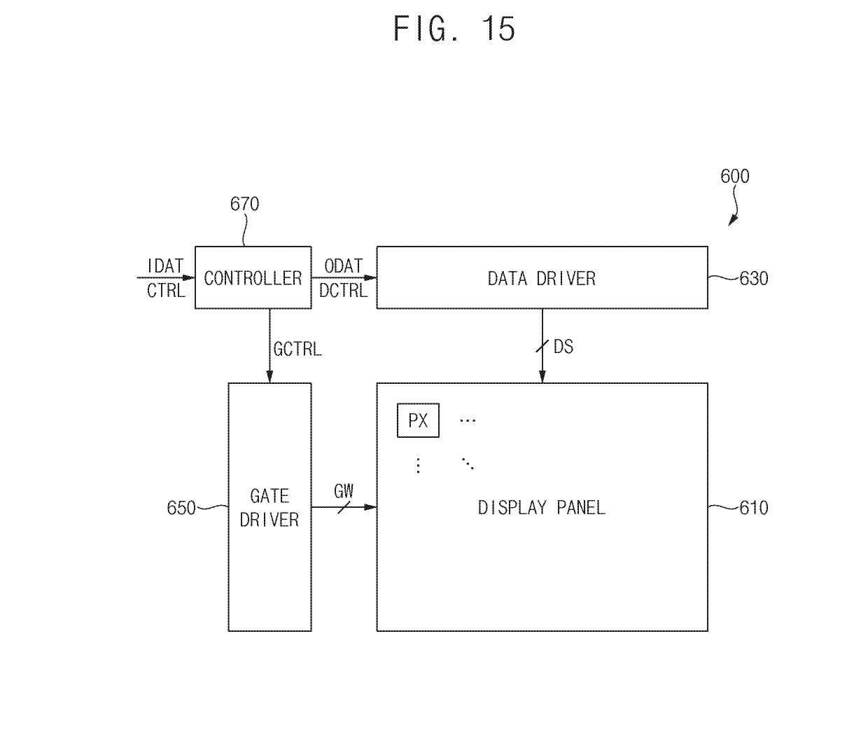

FIG. 15 is a block diagram illustrating a display device according to embodiments.

Referring to FIG. 15, a display device 600 according to embodiments may include a display panel 610 that includes a plurality of pixels PX, a data driver 630 that provides data signals DS to the plurality of pixels PX, a gate driver 650 that provides gate signals GW to the plurality of pixels PX., and a controller 670 that controls the data driver 630 and the gate driver 650.

The display panel 610 may include a plurality of data lines, a plurality of gate lines, and the plurality of pixels PX connected to the plurality of data lines and to the plurality of gate lines. In some embodiments, each pixel PX may include a light-emitting element, and the display panel 610 may be a light-emitting display panel. For example, the light-emitting element may be an organic light-emitting diode (“OLED”), a micro light-emitting diode, a nano light-emitting diode (“nano-LED”), a quantum dot (“QD”) light-emitting diode, an inorganic light-emitting diode, or any other suitable light-emitting element.

The data driver 630 may generate the data signals DS based on a data control signal DCTRL and output image data ODAT received from the controller 670, and may provide the data signals DS to the plurality of pixels PX through the plurality of data lines. In some embodiments, the data control signal DCTRL may include, but is not limited to, an output data enable signal, a horizontal start signal and a load signal. Further, in some embodiments, the data driver 630 and the controller 670 may be implemented as a single integrated circuit, and the single integrated circuit may be referred to as a timing controller embedded data driver (“TED”) integrated circuit. In other embodiments, the data driver 630 and the controller 670 may be implemented as separate integrated circuits.

The gate driver 650 may generate the gate signals GW based on a gate control signal GCTRL received from the controller 670, and may sequentially provide the gate signals GW to the plurality of pixels PX through the plurality of gate lines on a row-by-row basis. In some embodiments, the gate control signal GCTRL may include, but is not limited to, first and second carry clock signals CR_CLK1 and CR_CLK2, first, second, third, and fourth clock signals CLK1, CLK2, CLK3, and CLK4 and a start signal FLM illustrated in FIGS. 1 and 2. Further, according to embodiments, the gate driver 650 may be the gate driver 100 of FIG. 1 including a stage 200 of FIG. 3 or a stage 300 of FIG. 14. In some embodiments, the gate driver 650 may be integrated or formed in the display panel 610. In other embodiments, the gate driver 650 may be implemented with one or more integrated circuits.

The controller 670 (e.g., a timing controller) may receive input image data IDAT and a control signal CTRL from an external processor (e.g., a graphics processing unit (“GPU”), an application processor (“AP”) or a graphics card). In some embodiments, the input image data IDAT may be RGB image data including red image data, green image data and blue image data. Further, in some embodiments, the control signal CTRL may include, but is not limited to, a vertical synchronization signal, a horizontal synchronization signal, an input data enable signal, a master clock signal, etc. The controller 670 may generate the output image data ODAT, the data control signal DCTRL and the gate control signal GCTRL based on the input image data IDAT and the control signal CTRL. The controller 670 may control an operation of the data driver 630 by providing the output image data ODAT and the data control signal DCTRL to the data driver 630, and may control an operation of the gate driver 650 by providing the gate control signal GCTRL to the gate driver 650.

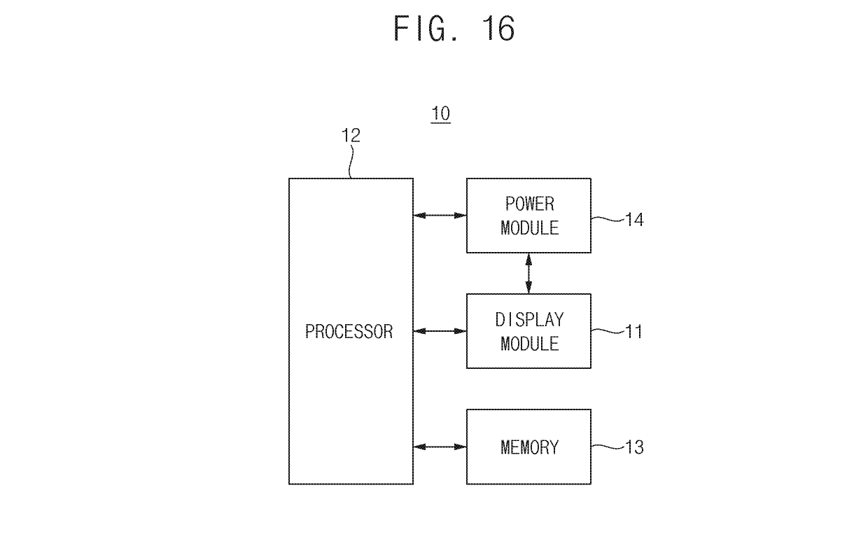

FIG. 16 is a block diagram illustrating an electronic device according to embodiments.

Referring to FIG. 16, an electronic device 10 according to embodiments may include a display module 11, a processor 12, a memory 13, and a power module 14.

The processor 12 may include at least one of a central processing unit (“CPU”), an application processor (“AP”), a graphics processing unit (“GPU”), a communication processor (“CP”), an image signal processor (“ISP”), or a controller.

The memory 13 may store data information for an operation of the processor 12 or the display module 11. When the processor 12 executes an application stored in the memory 13, an image data signal, and/or an input control signal may be transferred to the display module 11, and the display module 11 may output image information through a display screen by processing the received signal.

The power module 14 may include a power supply module, such as a power adapter or a battery device, and a power conversion module that converts power supplied by the power supply module to generate power required for an operation of the electronic device 10.

At least one of the components of the electronic device 10 described above may be included in the display device according to embodiments described above. Further, some of individual modules functionally included in one module may be included in the display device, and other modules may be provided separately from the display device. For example, the display device may include the display module 11, and the processor 12, the memory 13, and the power module 14 may be provided as other devices within the electronic device 10 other than the display device.

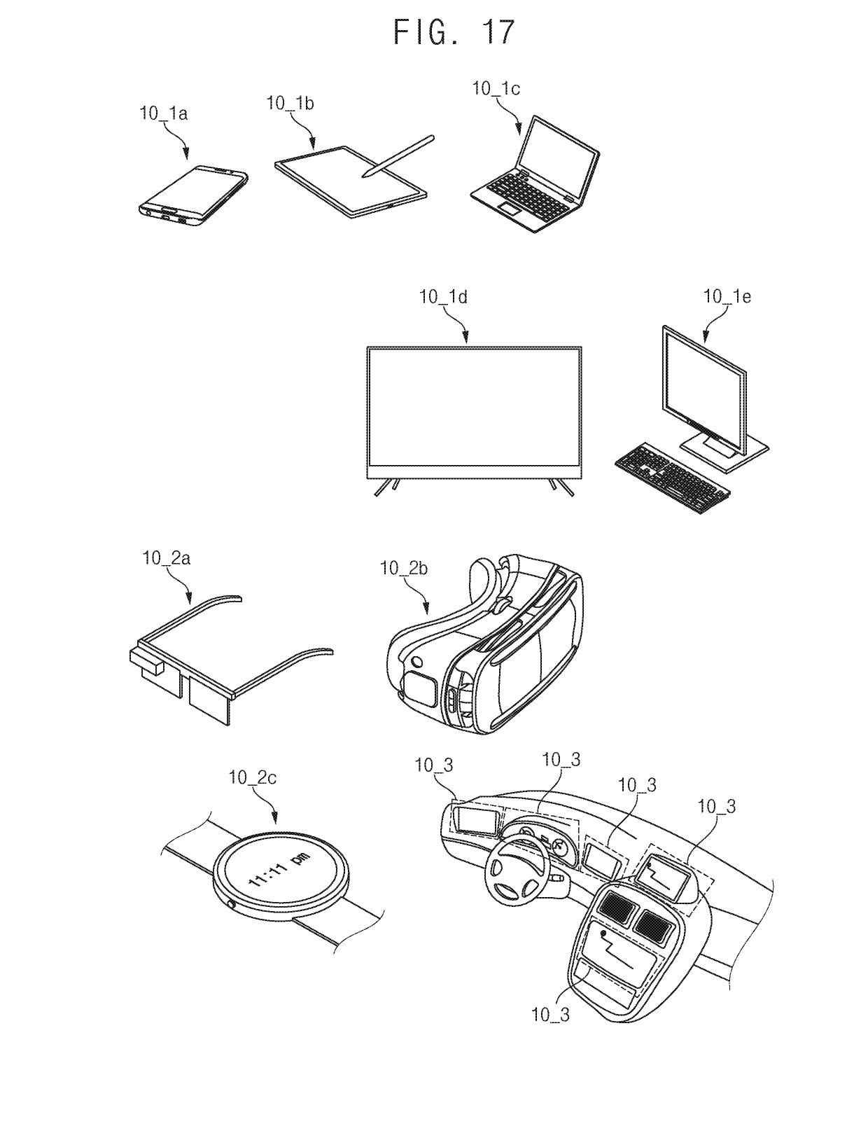

FIG. 17 is a schematic diagram of electronic devices according to various embodiments.

Referring to FIG. 17, various electronic devices to which the display device according to embodiments is applied may include not only image display electronic devices such as a smart phone 10_1a, a tablet personal computer (“PC”) 10_1b, a laptop 10_1c, a television (“TV”) 10_1d, and a desk monitor 10_1e, but also wearable electronic devices including display modules such as smart glasses 10_2a, a head mounted display 10_2b, and a smart watch 10_2c, and vehicle electronic devices 10_3 including display modules such as a center information display (“CID”) arranged on an instrument panel, center fascia and dashboard of an automobile, and a room mirror display.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims, with functional equivalents thereof to be included therein.

What is claimed is:

1. A gate driver comprising stages configured to receive a first carry clock signal, a second carry clock signal, a first clock signal, a second clock signal, a third clock signal, and a fourth clock signal, at least one stage of the stages comprising:
a logic circuit configured to control a voltage of a first node and a voltage of a second node based on the first carry clock signal and an input signal;
a first transistor comprising a gate configured to receive a high gate voltage, a first terminal connected to the first node, and a second terminal connected to a third node;
a second transistor comprising a gate configured to receive the high gate voltage, a first terminal connected to the first node, and a second terminal connected to a fourth node;
a first gate output circuit configured to output a first gate signal to a first gate line based on the second clock signal, a voltage of the third node, and the voltage of the second node;
a second gate output circuit configured to output a second gate signal to a second gate line that is different from the first gate line based on the third clock signal, a voltage of the fourth node, and the voltage of the second node;
a carry output circuit configured to output a carry signal to a next stage based on the second carry clock signal, the voltage of the fourth node, and the voltage of the second node; and
a first boosting capacitor connected between the fourth node and a carry output node for outputting the carry signal.

2. The gate driver of claim 1, wherein the first gate line is connected to a first pixel row, and
wherein the second gate line is connected to a second pixel row below the first pixel row.

3. The gate driver of claim 1, wherein the second gate signal is delayed by one horizontal time from the first gate signal.

4. The gate driver of claim 1, wherein the at least one stage has no boosting capacitor connected to the third node.

5. The gate driver of claim 1, wherein the at least one stage further comprises a second boosting capacitor connected between the third node and the first gate line, and
wherein a capacitance of the second boosting capacitor is less than a capacitance of the first boosting capacitor.

6. The gate driver of claim 1, wherein the second carry clock signal and the third clock signal have rising edges at a same time point, and
wherein a falling edge of the second carry clock signal lags behind a falling edge of the third clock signal.

7. The gate driver of claim 1, wherein the first carry clock signal, the second carry clock signal, the first clock signal, the second clock signal, the third clock signal, and the fourth clock signal have a pulse width corresponding to two horizontal times.

8. The gate driver of claim 1, wherein the first carry clock signal and the second carry clock signal have a first pulse width corresponding to two horizontal times, and
wherein the first clock signal, the second clock signal, the third clock signal, and the fourth clock signal have a second pulse width that is shorter than the first pulse width.

9. The gate driver of claim 1, wherein the first gate output circuit is configured to output the second clock signal as the first gate signal in response to the voltage of the third node, and is configured to output a low gate voltage as the first gate signal in response to the voltage of the second node,
wherein the second gate output circuit is configured to output the third clock signal as the second gate signal in response to the voltage of the fourth node, and is configured to output the low gate voltage as the second gate signal in response to the voltage of the second node, and
wherein the carry output circuit is configured to output the second carry clock signal as the carry signal in response to the voltage of the fourth node, and is configured to output another low gate voltage that is lower than the low gate voltage as the carry signal in response to the voltage of the second node.

10. The gate driver of claim 1, wherein the first gate output circuit comprises:
a third transistor comprising a gate connected to the third node, a first terminal configured to receive the second clock signal, and a second terminal connected to the first gate line; and
a fourth transistor comprising a gate connected to the second node, a first terminal connected to the first gate line, and a second terminal configured to receive a low gate voltage,
wherein the second gate output circuit comprises:
a fifth transistor comprising a gate connected to the fourth node, a first terminal configured to receive the third clock signal, and a second terminal connected to the second gate line; and
a sixth transistor comprising a gate connected to the second node, a first terminal connected to the second gate line, and a second terminal configured to receive the low gate voltage, and
wherein the carry output circuit comprises:
a seventh transistor comprising a gate connected to the fourth node, a first terminal configured to receive the second carry clock signal, and a second terminal connected to the carry output node; and
an eighth transistor comprising a gate connected to the second node, a first terminal connected to the carry output node, and a second terminal configured to receive another low gate voltage that is lower than the low gate voltage.

11. The gate driver of claim 1, wherein the logic circuit comprises:
an input circuit configured to transfer the input signal to the first node in response to the first carry clock signal; and
an inverter circuit configured to control the voltage of the second node based on the voltage of the third node.

12. The gate driver of claim 11, wherein the input circuit comprises a ninth transistor comprising a gate configured to receive the first carry clock signal, a first terminal configured to receive the input signal, and a second terminal connected to the first node.

13. The gate driver of claim 11, wherein the inverter circuit comprises:
a tenth transistor comprising a gate configured to receive the high gate voltage, a first terminal configured to receive the high gate voltage, and a second terminal;
an eleventh transistor comprising a gate connected to the second terminal of the tenth transistor, a first terminal configured to receive the high gate voltage, and a second terminal connected to the second node;
a capacitor comprising a first electrode connected to the gate of the eleventh transistor, and a second electrode connected to the second node;
a twelfth transistor comprising a gate connected to the third node, a first terminal connected to the gate of the eleventh transistor, and a second terminal configured to receive a low gate voltage; and
a thirteenth transistor comprising a gate connected to the third node, a first terminal connected to the second node, and a second terminal configured to receive another low gate voltage that is lower than the low gate voltage.

14. The gate driver of claim 11, wherein the logic circuit further comprises a reset circuit configured to provide a low gate voltage to the first node in response to a reset signal, the reset circuit comprising a fourteenth transistor comprising a gate configured to receive the reset signal, a first terminal connected to the first node, and a second terminal configured to receive the low gate voltage.

15. The gate driver of claim 11, wherein a ninth transistor of the input circuit comprises a first sub-transistor and a second sub-transistor that are connected in series, and
wherein the logic circuit further comprises a leakage reduction circuit configured to provide the high gate voltage to a node between the first sub-transistor and the second sub-transistor in response to the voltage of the third node, the leakage reduction circuit comprising a fifteenth transistor comprising a gate connected to the third node, a first terminal configured to receive the high gate voltage, and a second terminal connected to the node between the first sub-transistor and the second sub-transistor.

16. The gate driver of claim 11, wherein the logic circuit further comprises a stabilizing circuit configured to stabilize the voltage of the first node when the voltage of the second node has a high level, the stabilizing circuit comprising:
a sixteenth transistor comprising a gate configured to receive the second carry clock signal, a first terminal connected to the first node, and a second terminal; and
a seventeenth transistor comprising a gate connected to the second node, a first terminal connected to the second terminal of the sixteenth transistor, and a second terminal connected to the carry output node.

17. A gate driver comprising stages configured to receive a first carry clock signal, a second carry clock signal, a first clock signal, a second clock signal, a third clock signal, and a fourth clock signal, at least one stage of the stages comprising:
a logic circuit configured to control a voltage of a first node and a voltage of a second node based on the first carry clock signal and an input signal;
a first transistor comprising a gate configured to receive a high gate voltage, a first terminal connected to the first node, and a second terminal connected to a third node;
a second transistor comprising a gate configured to receive the high gate voltage, a first terminal connected to the first node, and a second terminal connected to a fourth node;
a first gate output circuit configured to output a first gate signal to a first gate line based on the second clock signal, a voltage of the third node, and the voltage of the second node;
a second gate output circuit configured to output a second gate signal to a second gate line that is different from the first gate line based on the third clock signal, a voltage of the fourth node, and the voltage of the second node; and
a carry output circuit configured to output a carry signal to a next stage based on the second carry clock signal, the voltage of the fourth node, and the voltage of the second node,
wherein the second carry clock signal and the third clock signal have rising edges at a same time point, and
wherein a falling edge of the second carry clock signal lags behind a falling edge of the third clock signal.

18. The gate driver of claim 17, wherein the at least one stage further comprises a boosting capacitor connected between the fourth node and a carry output node for outputting the carry signal.

19. An electronic device comprising:
a processor;
a memory connected to the processor;
a power module connected to the processor; and
a display device configured to receive input image data from the processor, and to display an image based on the input image data, the display device comprising:
a display panel comprising pixels;
a data driver configured to provide data signals to the pixels;
a gate driver configured to provide gate signals comprising a first gate signal and a second gate signal to the pixels; and
a controller configured to control the data driver and the gate driver,
wherein the gate driver comprises stages configured to receive a first carry clock signal, a second carry clock signal, a first clock signal, a second clock signal, a third clock signal, and a fourth clock signal, at least one stage of the stages comprising:
a logic circuit configured to control a voltage of a first node and a voltage of a second node based on the first carry clock signal and an input signal;
a first transistor comprising a gate configured to receive a high gate voltage, a first terminal connected to the first node, and a second terminal connected to a third node;
a second transistor comprising a gate configured to receive the high gate voltage, a first terminal connected to the first node, and a second terminal connected to a fourth node;
a first gate output circuit configured to output the first gate signal to a first gate line based on the second clock signal, a voltage of the third node, and the voltage of the second node;
a second gate output circuit configured to output the second gate signal to a second gate line that is different from the first gate line based on the third clock signal, a voltage of the fourth node, and the voltage of the second node;
a carry output circuit configured to output a carry signal to a next stage based on the second carry clock signal, the voltage of the fourth node, and the voltage of the second node; and
a boosting capacitor connected between the fourth node and a carry output node for outputting the carry signal.

20. The electronic device of claim 19, wherein the second carry clock signal and the third clock signal have rising edges at a same time point, and
wherein a falling edge of the second carry clock signal lags behind a falling edge of the third clock signal.
